(19) United States
(12) Patent Application Publication
(10) Pub. No.: US 2007/0295306 A1
(43) Pub. Date: Dec. 27, 2007

(54) Fuel injection valve

(75) Inventors: Tetsuya Yoshimura, Toyota-city (JP); Keisuke Suzuki, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/808,994

(22) Filed: Jun. 14, 2007

(30) Foreign Application Priority Data
Jun. 21, 2006 (JP) 2006-170955

(51) Int. Cl. F02M 69/16

(52) U.S. Cl. 123/445

(57) ABSTRACT

A fuel injection valve includes a valve element, an actuator, a control chamber, and a nozzle. The valve element is provided in a valve chamber. The control chamber is always communicated with the valve chamber. S3>S1>S2 is satisfied in a condition, where the followings are satisfied. S1 is a passage area of a high-pressure seat portion of the valve chamber, which area is a product of a peripheral length of the high-pressure seat portion multiplied by a lift amount of the valve element in a state, where the valve element is disengaged from the high-pressure seat portion. S2 is a passage area of the high-pressure restrictor. S3 is a passage area of the high-pressure fuel passage.

### CROSS REFERENCE TO RELATED APPLICATION

This application is based on and incorporates herein by reference Japanese Patent Application No. 2006-170955 filed on Jun. 21, 2006.

### BACKGROUND OF THE INVENTION

1. Field of the Invention

The present invention relates to a fuel injection valve, which injects fuel to a heat engine.

2. Description of Related Art

A conventional fuel injection valve includes a nozzle, a valve element, an actuator, and a control chamber. The nozzle includes a nozzle needle for opening and closing an injection orifice. The valve element is provided inside a valve chamber, and is engaged with or disengaged from a low-pressure seat portion to prohibit and allow communication between the valve chamber and a low-pressure fuel passage. Also, the valve element is engaged with and disengaged from a high-pressure seat portion to prohibit and allow communication between the valve chamber and a high-pressure fuel passage. The actuator actuates the valve element. The control chamber is always communicated with the valve chamber through a communication passage. The nozzle needle is biased in a valve closing direction for closing the injection orifice by fuel pressure in the control chamber. Thus, the valve element controls pressure in the control chamber such that an opening and closing operation of the nozzle needle is controlled. Also, the high-pressure fuel passage is provided with a high-pressure restrictor (see, for example, JP-A-2001-500218).

In the above-structured fuel injection valve, a valve closing speed of the nozzle needle for closing the injection orifice is determined based on a flow amount of fuel flowing into the control chamber per unit time (hereinafter, referred as a fuel inlet velocity). Also, the fuel inlet velocity is determined based on a passage area of the high-pressure seat portion in a condition, where the valve element is disengaged from the high-pressure seat portion, and based on a passage area of the high-pressure restrictor. Typically, the passage area of the high-pressure seat portion in the condition, where the valve element is disengaged from the high-pressure seat portion, is equal to a peripheral length of the high-pressure seat portion×a lift amount of the valve element (e.g., is equal to a product of the peripheral length of the high-pressure seat portion multiplied by the lift amount of the valve element). Hereinafter, this is referred as the passage area of the high-pressure seat portion.

However, JP-A-2001-500218 does not discloses a relation in magnitude between the passage area of the high-pressure seat portion and the passage area of the high-pressure fuel passage, nor a relation in magnitude between the passage area of the high-pressure seat portion and the passage area of the high-pressure restrictor. When the passage area of the high-pressure seat portion is made smaller than the passage area of the high-pressure restrictor, the passage area of the high-pressure seat portion may change in a case, where the lift amount of the valve element varies with time. Thus, the fuel inlet velocity varies such that the valve closing speed of the nozzle needle also varies. As a result, an injection quantity may vary. In other words, injection quantity may disadvantageously change due to the change of the lift amount of the valve element with time.

### SUMMARY OF THE INVENTION

The present invention is made in view of the above disadvantages. Thus, it is an objective of the present invention to address at least one of the above disadvantages.

To achieve the objective of the present invention, there is provided a fuel injection valve, which includes a valve element, an actuator, a control chamber, and a nozzle. The valve element is provided in a valve chamber, wherein the valve element is engaged with and disengaged from a low-pressure seat portion of the valve chamber to prohibit and allow communication between the valve chamber and a low-pressure fuel passage. The valve element is engaged with and disengaged from a high-pressure seat portion of the valve chamber to prohibit and allow communication between the valve chamber and a high-pressure fuel passage. The actuator actuates the valve element. The control chamber is always communicated with the valve chamber. The nozzle has a nozzle needle for opening and closing an injection orifice, wherein the nozzle needle is biased in a valve closing direction for closing the injection orifice by fuel pressure in the control chamber. The high-pressure fuel passage is provided with a high-pressure restrictor. S3>S1>S2 is satisfied in a condition, where the followings are satisfied. S1 is a passage area of the high-pressure seat portion, which area is a product of a peripheral length of the high-pressure seat portion multiplied by a lift amount of the valve element in a state, where the valve element is disengaged from the high-pressure seat portion. S2 is a passage area of the high-pressure restrictor. S3 is a passage area of the high-pressure fuel passage.

### BRIEF DESCRIPTION OF THE DRAWINGS

The invention, together with additional objectives, features and advantages thereof, will be best understood from the following description, the appended claims and the accompanying drawings in which:

FIG. 1 is a cross-sectional view showing a general structure of a fuel injection system having a fuel injection valve according to one embodiment of the present invention;

FIG. 2 is an enlarged cross-sectional view of a portion II of FIG. 1;

FIG. 3 is an enlarged cross-sectional view of a portion III of FIG. 2;

FIG. 4 is a chart showing an analysis result of a relation between an area ratio (=S1/S2) and a lift to injection-quantity sensitivity of the fuel injection valve according to the one embodiment; and

FIG. 5 is a chart showing an analysis result of a relation between the area ratio (=S1/S2) and a flow amount ratio of the fuel injection valve according to the one embodiment.

### DETAILED DESCRIPTION OF PREFERRED EMBODIMENTS

One embodiment of the present invention is described referring to accompanying drawings. A fuel injection valve is mounted on a cylinder head of an internal combustion engine (more specifically, a diesel engine, which is not shown). The fuel injection valve injects high pressure fuel accumulated in an accumulator (not shown) into a cylinder of the internal combustion engine.

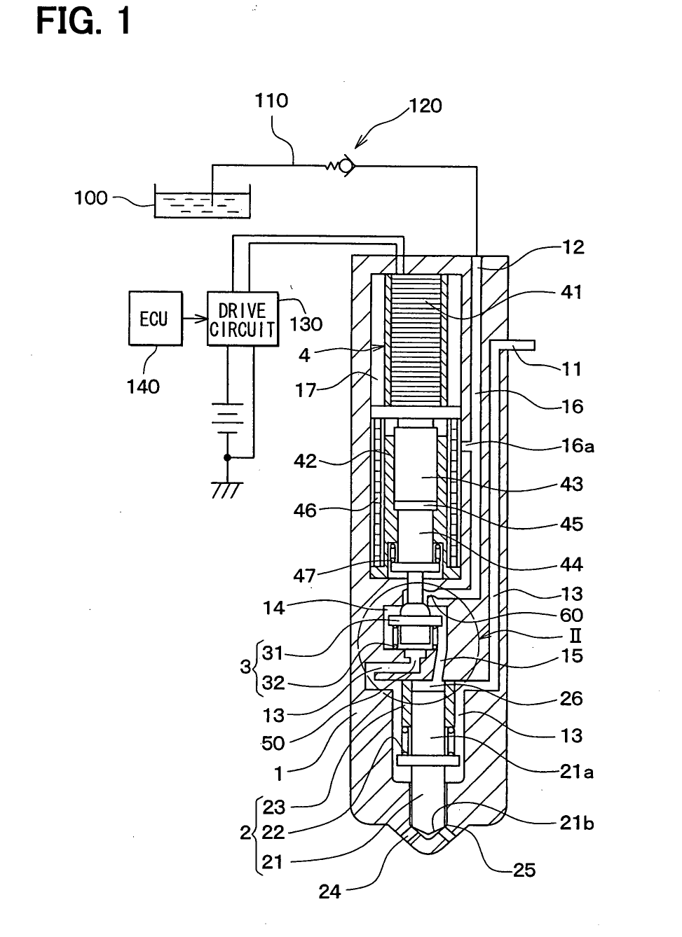

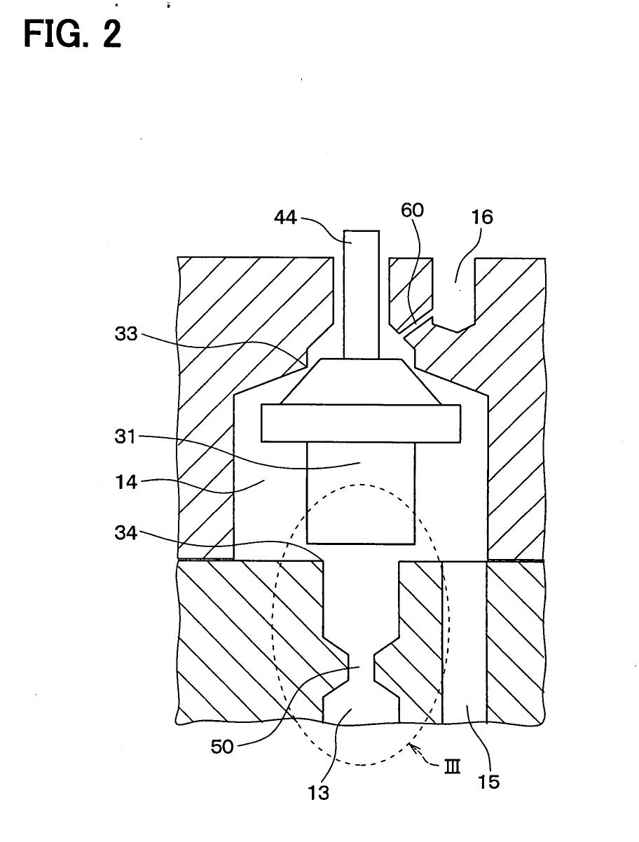

As shown in FIGS. 1 to 3, a body 1 of the fuel injection valve includes a fuel inlet port 11, into which high pressure fuel from the accumulator is introduced, and a fuel outlet port 12, through which the fuel inside the fuel injection valve flows to a fuel tank 100.

A nozzle 2, which injects fuel at a valve opening state, where the valve is opened, is placed at one end of the body 1 in a longitudinal direction (at one longitudinal end of the body 1). The nozzle 2 has a nozzle needle 21, a nozzle spring 22, and a nozzle cylinder 23. The nozzle needle 21 is slidably held by the body 1. The nozzle spring 22 biases the nozzle needle 21 in a valve closing direction for closing the valve. The nozzle cylinder 23 receives a piston portion 21a of the nozzle needle 21.

At the one longitudinal end of the body 1, injection orifices 24, which communicate with the fuel inlet port 11 through a high-pressure fuel passage 13, is formed, and it is designed that high pressure fuel is injected through the injection orifices 24 into the cylinder of the internal combustion engine. A taper-shaped valve seat 25 is formed upstream of the injection orifices 24, and the injection orifices 24 are opened or closed by engaging and disengaging a seat portion 21b, which is formed in the nozzle needle 21, with and from the valve seat 25.

The nozzle cylinder 23 slidably and fluid tightly receives a piston portion 21a, and the piston portion 21a and the nozzle cylinder 23 defines a control chamber 26, in which internal fuel pressure is changed between a high pressure and a low pressure. And the nozzle needle 21 is biased in the valve closing direction by fuel pressure in the control chamber 26, and also the nozzle needle 21 is biased in the valve opening direction for opening the valve (e.g., for opening the injection orifices 24) by high pressure fuel, which is introduced from the fuel inlet port 11 toward the injection orifices 24 through the high-pressure fuel passage 13.

In a longitudinal intermediate part of the body 1, a valve chamber 14, which receives a control valve 3 controlling pressure in the control chamber 26, is formed. The control chamber 26 is always communicated with the valve chamber 14 through a communication passage 15.

The valve chamber 14 is connected with the fuel inlet port 11 through the high-pressure fuel passage 13. The high-pressure fuel passage 13 is provided with a high-pressure restrictor 50. Also, the valve chamber 14 is connected with the fuel outlet port 12 through a low-pressure fuel passage 16. The low-pressure fuel passage 16 is provided with a low-pressure restrictor 60.

The control valve 3 has a valve element 31 and a valve spring 32. The valve element 31 is engaged with and disengaged from a low-pressure seat portion 33 to prohibit and allow communication between the valve chamber 14 and the low-pressure fuel passage 16, and the valve element 31 is engaged with and disengaged from a high-pressure seat portion 34 to prohibit and allow communication between the valve chamber 14 and the high-pressure fuel passage 13. The valve spring 32 biases the valve element 31 in a direction for opening (allowing) the communication between the valve chamber 14 and the high-pressure fuel passage 13 and at the same time for closing (prohibiting) the communication between the valve chamber 14 and the low-pressure fuel passage 16.

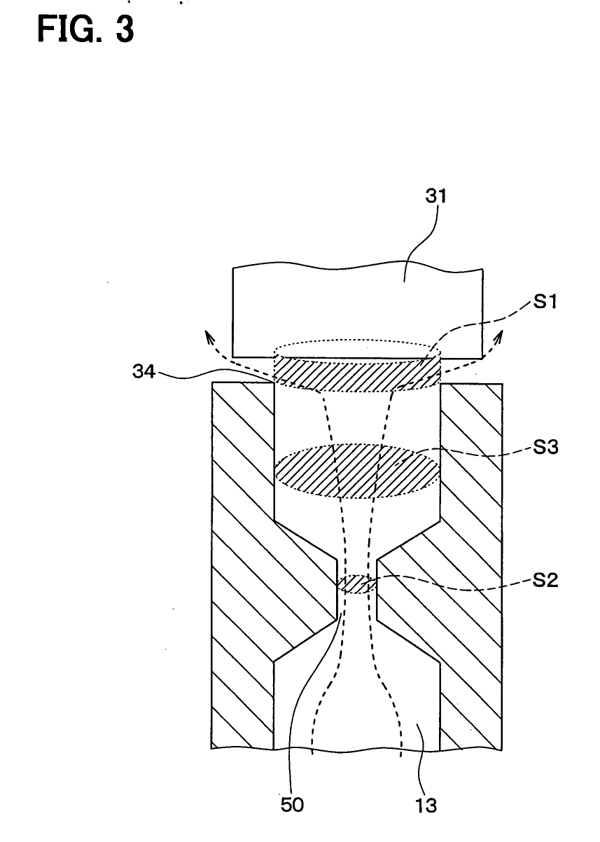

Here, referring to FIG. 3, S3>S1>S2 is satisfied in the following condition. S1 is a passage area the high-pressure seat portion 34. S2 is a passage area of the high-pressure restrictor 50. S3 is a passage area of the high-pressure fuel passage 13. Typically, the passage area S1 of the high-pressure seat portion 34 is a product of a peripheral length of the high-pressure seat portion 34 multiplied by a lift amount of the valve element 31 (hereinafter, referred as a valve element lift amount) in a state, where the valve element 31 is disengaged from (is positioned apart from) the high-pressure seat portion 34. For example, the valve element lift amount indicated here is a distance between the end face of the valve element 31 and the high-pressure seat portion 34 in a direction of displacement of the valve element 31. Also, the passage area S3 of the high-pressure fuel passage 13 corresponds to a passage area of a part (other than the high-pressure restrictor 50) with a minimum passage area of the high-pressure fuel passage 13, which connects between the fuel inlet port 11 and the high-pressure seat portion 34.

An actuator chamber 17, which receives an actuator 4 actuating (driving) the control valve 3, is formed at the other longitudinal end of the body 1. The actuator chamber 17 is connected to the low-pressure fuel passage 16 through a low-pressure communication passage 16a.

The actuator 4 includes a piezoelectric stack 41 and a transmission portion. The piezoelectric stack 41 has multiple piezoelectric elements, which are laminated onto one another, and expands and contracts by charging and discharging the electric charge. The transmission portion transmits a displacement of the piezoelectric stack 41, which is caused by the expansion and contraction, to the valve element 31 of the control valve 3.

The transmission portion is constructed as follows. A first piston 43 and a second piston 44 are slidably and fluid tightly received by an actuator cylinder 42, and a fluid chamber 45, which is filled with fuel, is provided between the first piston 43 and the second piston 44.

The first piston 43 is biased toward the piezoelectric stack 41 by a first spring 46, and is driven by the piezoelectric stack 41 directly. And, at the time of the extension of the piezoelectric stack 41, pressure in the fluid chamber 45 is raised by the first piston 43.

The second piston 44 is biased toward the valve element 31 of the control valve 3 by a second spring 47, and is operated to drive the valve element 31 by pressure in the fluid chamber 45. At the time of the extension of the piezoelectric stack 41, pressure in the fluid chamber 45, which is made higher, drives the second piston 44 such that the communication between the valve chamber 14 and the high-pressure fuel passage 13 is prohibited. Along with this, the second piston 44 drives the valve element 31 in a position, where the communication between the valve chamber 14 and the low-pressure fuel passage 16 is allowed. In contrast, at a time of contraction of the piezoelectric stack 41, namely when pressure in the fluid chamber 45 is low, the second piston 44 resists the second spring 47, and is pushed back by the valve spring 32 of the control valve 3 toward the first piston 43.

A return passage 110 connects the fuel outlet port 12 with the fuel tank 100, and the return passage 110 has a back-pressure valve 120 at one side thereof toward the low-pressure fuel passage 16 for controlling pressure in the low-pressure fuel passage 16. By the way, the back-pressure valve 120 controls the pressure in the low-pressure fuel passage 16 at generally 1 MPa whereas pressure in high pressure fuel accumulated in the accumulator is equal to or greater than 100 MPa.

An electric power is supplied through a piezoelectric drive circuit 130 to the piezoelectric stack 41. Electrification timing of the piezoelectric drive circuit 130 to the piezoelectric stack 41 is controlled by an electronic control circuit (hereinafter, referred as ECU) 140.

The ECU 140 includes a known microcomputer having a CPU, ROM, an EEPROM, and a RAM, all of which are not illustrated, and executes computing processes in accordance with programs stored in the microcomputer. Signals are inputted into the ECU 140 through various sensors (not shown) detecting an intake air amount, a depression amount of an accelerator pedal, a rotational speed of the internal combustion engine, and fuel pressure in the accumulator.

An operation of the fuel injection valve is described below. When the piezoelectric stack 41 is energized, the piezoelectric stack 41 expands and the first piston 43 is driven to raise pressure in the fluid chamber 45. The second piston 44 is driven toward the valve element 31 of the control valve 3 by pressure in the fluid chamber 45, which is thus made higher.

Then, because the valve element 31 is driven with the second piston 44, the valve element 31 contacts with (is engaged with) the high-pressure seat portion 34 such that the communication between the valve chamber 14 and the high-pressure fuel passage 13 is prohibited. Along with this, the valve element 31 is placed apart from (is disengaged from) the low-pressure seat portion 33 such that the communication between the valve chamber 14 and the low-pressure fuel passage 16 is allowed. Thus, fuel in the control chamber 26 is returned to the fuel tank 100 through the communication passage 15, the valve chamber 14, the low-pressure restrictor 60, and the low-pressure fuel passage 16.

Due to this, pressure in the control chamber 26 falls and the force biasing the nozzle needle 21 in the valve closing direction is reduced. Thus, the nozzle needle 21 moves in the valve opening direction so that the seat portion 21b is disengaged from the valve seat 25. As a result, the injection orifices 24 are opened, and fuel is injected into the cylinder of the internal combustion engine through the injection orifices 24.

After this, when energization to the piezoelectric stack 41 is stopped, the piezoelectric stack 41 contracts, and therefore the first piston 43 is returned toward the piezoelectric stack 41 by the first spring 46. Also, by the valve spring 32, the valve element 31 and the second piston 44 are returned toward the first piston 43.

Due to this, the valve element 31 is separated apart from (is disengaged from) the high-pressure seat portion 34 such that the communication between the valve chamber 14 and the high-pressure fuel passage 13 is allowed. Along with this, the valve element 31 contacts with (is engaged with) the low-pressure seat portion 33 such that the communication between the valve chamber 14 and the low-pressure fuel passage 16 is prohibited. Thus, high pressure fuel from the accumulator is introduced into the control chamber 26 through the high-pressure fuel passage 13, the high-pressure restrictor 50, the valve chamber 14, and the communication passage 15.

As a result, pressure in the control chamber 26 rises, and therefore, a biasing force that biases the nozzle needle 21 in the valve closing direction becomes larger. Therefore, the nozzle needle 21 moves in the valve closing direction, and the seat portion 21b seats on (is engaged with) the valve seat 25 such that the injection orifices 24 are closed. Thus, the fuel injection is finished.

Here, because S1>S2 is satisfied, a flow amount of fuel flowing into the control chamber 26 per unit time (fuel inlet velocity) is determined mainly by the passage area S2 of the high-pressure restrictor 50. As a result, this reduces the change of the injection quantity due to a change with time of the valve element lift amount. Also, the passage area S1 of the high-pressure seat portion 34 and the passage area S2 of the high-pressure restrictor 50 are made smaller than the passage area S3 of the high-pressure fuel passage 13. In other words, because double restrictors (e.g., the high-pressure seat portion 34 and the high-pressure restrictor 50) are provided, a large decrease of the fuel inlet velocity can be limited.

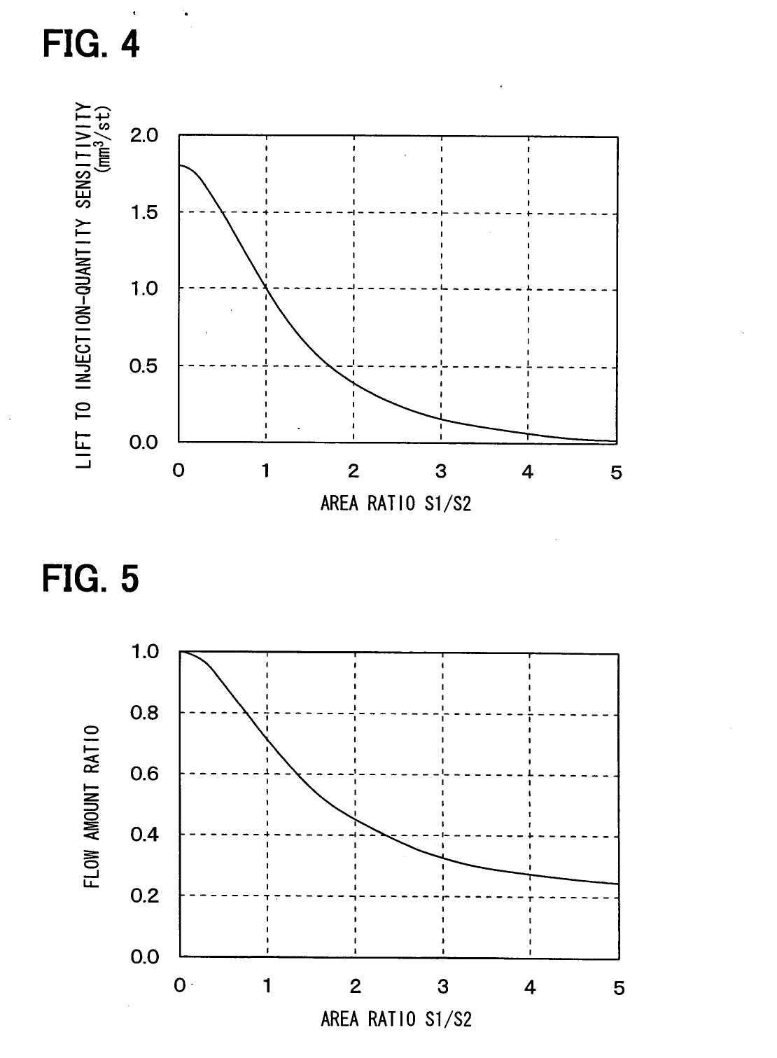

FIG. 4 is a chart showing an analysis result of a relation between an area ratio (=S1/S2) and a lift to injection-quantity sensitivity of the fuel injection valve according to the present embodiment. Here, the passage area S1 of the high-pressure seat portion 34 is fixed, and the passage area S2 of the high-pressure restrictor 50 is changed such that the area ratio is accordingly set. In the analysis, firstly, in the fuel injection valve of each area ratio, the valve element lift amount is set at 21 , m as an initial state. Then, an injection condition for evaluation is set for the fuel injection valve of each area ratio under the initial state as an injection condition, where the injection quantity is targeted at 80 mm³/st. While each fuel injection valve is operated under the injection condition for evaluation, the valve element lift amount is increased. At this time, an amount of decrease in the injection quantity per the increase of the valve element lift amount of 1 , m is analyzed. In FIG. 4, a horizontal axis indicates the above set area ratio, and a vertical axis indicates the lift to injection-quantity sensitivity, which corresponds to the above analyzed amount of decrease in the injection quantity.

As shown in FIG. 4, by enlarging the area ratio, the lift to injection-quantity sensitivity is reduced. When a change of the valve element lift amount due to the change with time (e.g., an aged deterioration) of an apparatus of an actual use is considered, 1.5≦S1/S2 is required.

FIG. 5 is a chart showing an analysis result of a relation between the area ratio (=S1/S2) and a flow amount ratio of the fuel injection valve according to the present embodiment. For example, the flow amount ratio is a ratio of the fuel inlet velocity at each area ratio relative to a fuel inlet velocity in a case, where the high-pressure restrictor 50 is not provided.

As shown in FIG. 5, when the area ratio is enlarged, the flow amount ratio is reduced. When the flow amount ratio is substantially reduced, the valve closing speed of the nozzle needle 21 may disadvantageously reduced. Thus, in practical use, S1/S2≦2.5 is required, and S1/S2≦2 is more required.

Therefore, when the lift to injection-quantity sensitivity and the valve closing speed of the nozzle needle 21 are considered, 1.5≦S1/S2≦2.5 is required. Furthermore, 1.5≦S1/S2≦2 is more required. As a result, the valve closing speed of the nozzle needle 21 is reliably limited from greatly decreasing, and at the same time, this reliably reduces the change of the injection quantity due to the change with time of the valve element lift amount.

Additional advantages and modifications will readily occur to those skilled in the art. The invention in its broader terms is therefore not limited to the specific details, representative apparatus, and illustrative examples shown and described.

What is claimed is:

1. A fuel injection valve comprising:
a valve element that is provided in a valve chamber, wherein:
the valve element is engaged with and disengaged from a low-pressure seat portion of the valve chamber to prohibit and allow communication between the valve chamber and a low-pressure fuel passage; and
the valve element is engaged with and disengaged from a high-pressure seat portion of the valve chamber to prohibit and allow communication between the valve chamber and a high-pressure fuel passage;
an actuator that actuates the valve element;
a control chamber that is always communicated with the valve chamber; and
a nozzle that has a nozzle needle for opening and closing an injection orifice, wherein the nozzle needle is biased in a valve closing direction for closing the injection orifice by fuel pressure in the control chamber, wherein:
the high-pressure fuel passage is provided with a high-pressure restrictor; and
S3>S1>S2 is satisfied in a condition, where the followings are satisfied:
S1 is a passage area of the high-pressure seat portion, which area is a product of a peripheral length of the high-pressure seat portion multiplied by a lift amount of the valve element in a state, where the valve element is disengaged from the high-pressure seat portion;
S2 is a passage area of the high-pressure restrictor; and
S3 is a passage area of the high-pressure fuel passage.

2. The fuel injection valve according to claim 1, wherein:
1.5≦S1/S2≦2.5 is satisfied.

3. The fuel injection valve according to claim 2, wherein:
1.5≦S1/S2≦2 is satisfied.
